(19) United States
(12) Patent Application Publication
(10) Pub. No.: US 2017/0024072 A1
(43) Pub. Date: Jan. 26, 2017

(54) INPUT DEVICE AND CONTROL PROGRAM

(71) Applicant: SHARP KABUSHIKI KAISHA, Sakai City (JP)

(72) Inventor: Yoichi KUGE, Sakai City (JP)

(21) Appl. No.: 15/124,392

(22) PCT Filed: Feb. 19, 2015
(86) PCT No.: PCT/JP2015/054645

§ 371 Date: Sep. 8, 2016

(30) Foreign Application Priority Data
Mar. 13, 2014 (JP) 2014-050614

(51) Int. Cl. G06F 3/041

(52) U.S. Cl. CPC G06F 3/0418; G06F 3/0412; G06F 2203/04108

(57) ABSTRACT

Even when a slide operation is performed over a boundary between a plurality of touch panels arranged so as to be adjacent to one another, the operation can be detected appropriately. An input device 1 includes a plurality of touch panels 101 to 104 arranged so as to be adjacent to each other. A controller 11 detects an input operation as to each of the touch panels, and outputs contact information that contains a contact position on a touch panel coordinate plane corresponding to the input operation on the touch panel, and release detection information that indicates whether or not the contact position is a release position at which the contact with the touch panel stopped. In a case where the contact position in the contact information for one of the touch panels is a release position, when a contact position on another touch panel exists in a predetermined area defined on the basis of the release position, the input device 1, using a coordinate output device 12, determines the contact position on the another touch panel to be the input position, and outputs the same as a contact position associated with the input operation corresponding to the release position, to a control device 3.

### TECHNICAL FIELD

The present invention relates to an input device, and a control program.

### BACKGROUND ART

In recent years, display devices having a touch panel stacked on a display panel have been in widespread use. Further, as the enlargement of the display panel is promoted, techniques for enlarging the touch panel are proposed.

JP-A-2013-229010 discloses a large-size touch panel having a plurality of detection areas. This touch panel detects a touch position in a detection area with use of controllers corresponding to the respective detection areas, and using the respective touch positions detected by the controllers, calculates respective positions corresponding to the touch positions in the entire area of the touch panel.

### SUMMARY OF THE INVENTION

In the case of the touch panel having a plurality of independent sensor areas, as is the case with JP-A-2013-229010, when a finger touches a position on a boundary between one of the sensor areas and another of the same that are adjacent to each other, the position touched by the finger is detected in each of the two sensor areas. In a case where, for example, a line is drawn by sliding a finger from one of the sensor areas to another, the two contact positions in the vicinities of the boundary between one sensor areas and the other sensor area are detected as two independent points, even though they result from a series of contacts that are continuous from one to the other, and a line is drawn with a break in the vicinities of the boundary.

The present invention provides a technique for detecting contents of an operation appropriately even if the operation is to input a sliding action over a boundary between adjacent touch panels among a plurality of touch panels arranged so as to be adjacent to one another.

An input device according to the first invention includes: a contact detection unit including a plurality of touch panels arranged so as to adjacent to one another, the contact detection unit detecting, as to each of the touch panels, an input operation on the touch panel, and outputting contact information that contains a contact position on the touch panel corresponding to the input operation, and release detection information that indicates whether or not the contact position is a release position at which the contact with the touch panel stopped; a determination unit that determines an input position with respect to an entire surface of the plurality of touch panels, based on the contact position in the contact information output by the contact detection unit; and an output unit that outputs the contact position determined to be the input position, as a contact position associated with the input operation corresponding to the said contact position, the input operation being detected by the contact detection unit, wherein, in a case where the release detection information contained in the contact information for one of the touch panels indicates that the contact position is a release position, when a contact position on another touch panel exists in a predetermined area defined on the basis of the release position, the determination unit determines the contact position on the another touch panel to be the input position, and the output unit outputs the contact position on the another touch panel, which is determined to be the input position, as a contact position associated with the input operation corresponding to the release position on the one of the touch panels, the input operation being detected by the contact detection unit.

The second invention is such that, in the first invention, when the release position on the one of the touch panels is within a boundary area that includes a boundary with the another touch panel, in the one of the touch panels that includes the release position, the determination unit determines whether or not the contact position on the another touch panel exists within the predetermined area.

The third invention is such that, in the first or second invention, the determination unit determines a contact position on the another touch panel that is located at the shortest distance to the release position on the one of the touch panels and exists within the predetermined area, to be the input position.

The fourth invention is such that, in the first or second invention, the determination unit specifies a vector direction based on the release position on the one of the touch panels and another contact position on the one of the touch panels, and determines a contact position on the another touch panel positioned in the vector direction starting from the release position as a starting point, to be the input position.

The fifth invention is such that, in any one of the second to fourth inventions, in a case where the release detection information contained in the contact information for the one of the touch panels indicates that the contact position is not a release position, when a contact position on another touch panel is included in a predetermined area that is within the boundary area in the touch panel including the contact position of the contact information and is defined on the basis of the contact position, the determination unit determines the contact position to be the input position, and the input device further includes a correction unit that corrects the contact position determined to be the input position, using the contact position on the another touch panel.

A control program according to the sixth invention causes a computer of an input device that includes a plurality of touch panels arranged so as to be adjacent to one another to execute: a contact detection step of detecting, as to each of the touch panels, an input operation on the touch panel, and outputting contact information that contains a contact position on the touch panel corresponding to the input operation, and release detection information that indicates whether or not the contact position is a release position at which the contact with the touch panel stopped; a determination step of determining an input position with respect to an entire surface of the plurality of touch panels, based on the contact position in the contact information output by the contact detection step; and an output step of outputting the contact position determined to be the input position, as a contact position associated with the input operation corresponding to the said contact position, the input operation being detected in the contact detection step, wherein, in a case where the release detection information contained in the contact information for one of the touch panels indicates that the contact position is a release position, when a contact position on another touch panel exists within a predetermined area defined on the basis of the release position, the determination step determines the contact position on the another touch panel to be the input position, and the output step outputs the contact position on the another touch panel, which is determined to be the input position, as a contact position associated with the input operation corresponding to the release position on the one of the touch panels, the input operation being detected in the contact detection step.

The configuration of the present invention enables the following: even when a slide operation is performed over a boundary between a plurality of touch panels arranged so as to be adjacent to one another, the contents of the operation can be detected appropriately.

### BRIEF DESCRIPTION OF DRAWINGS

FIG. 1 is a block diagram illustrating a schematic configuration of an input device according to Embodiment 1.

FIG. 2 is a functional block diagram of a coordinate output device illustrated in FIG. 1.

FIG. 3A explains boundary areas in touch panels illustrated in FIG. 1.

FIG. 3B illustrates exemplary boundary areas in third and fourth touch panels illustrated in FIG. 3A.

FIG. 30 explains an exclusion area.

FIG. 4 illustrates a flowchart of an exemplary operation of the input device according to Embodiment 1.

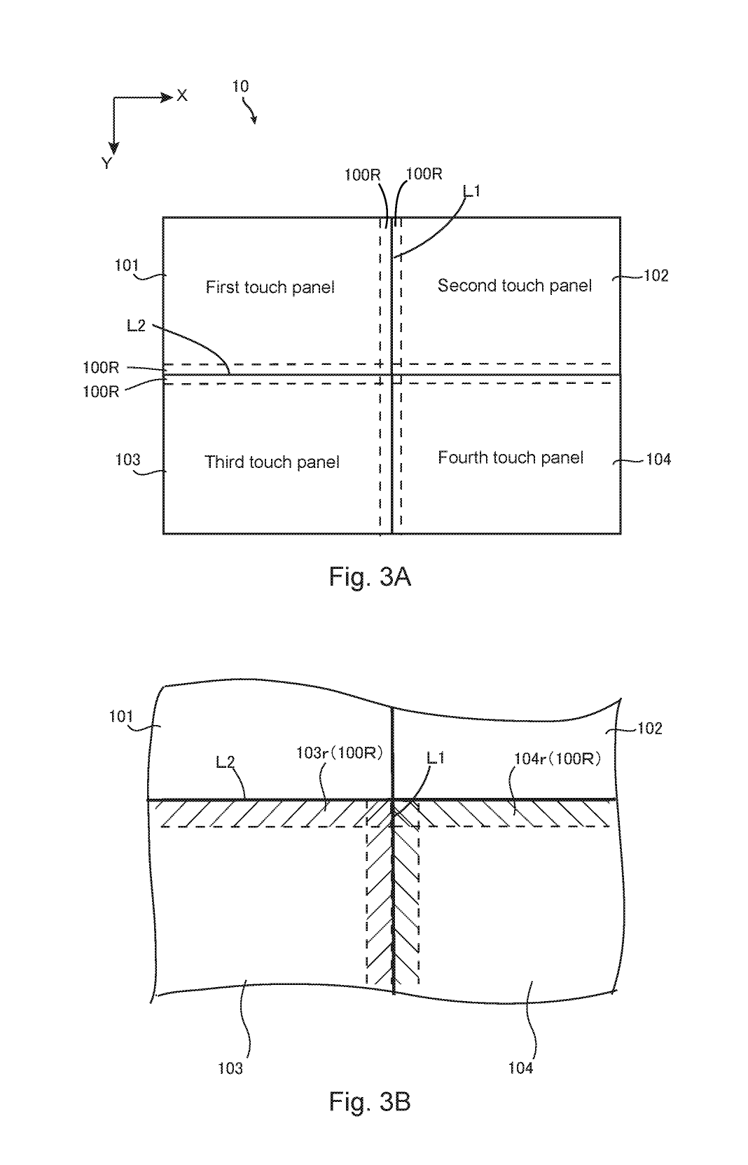

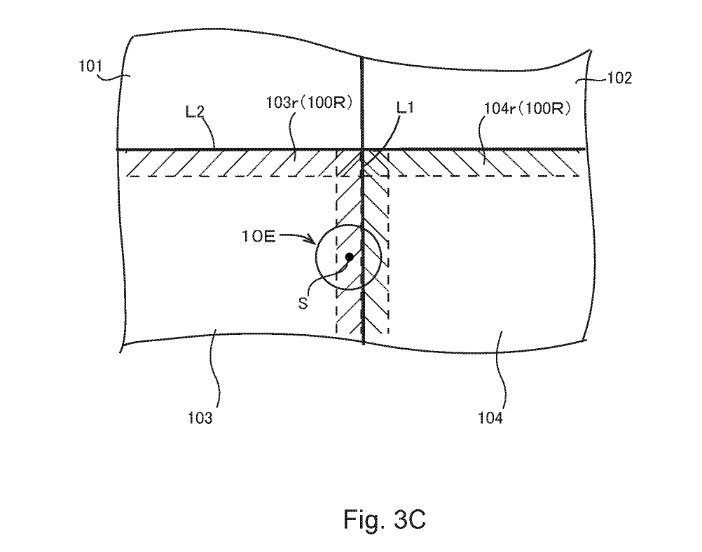

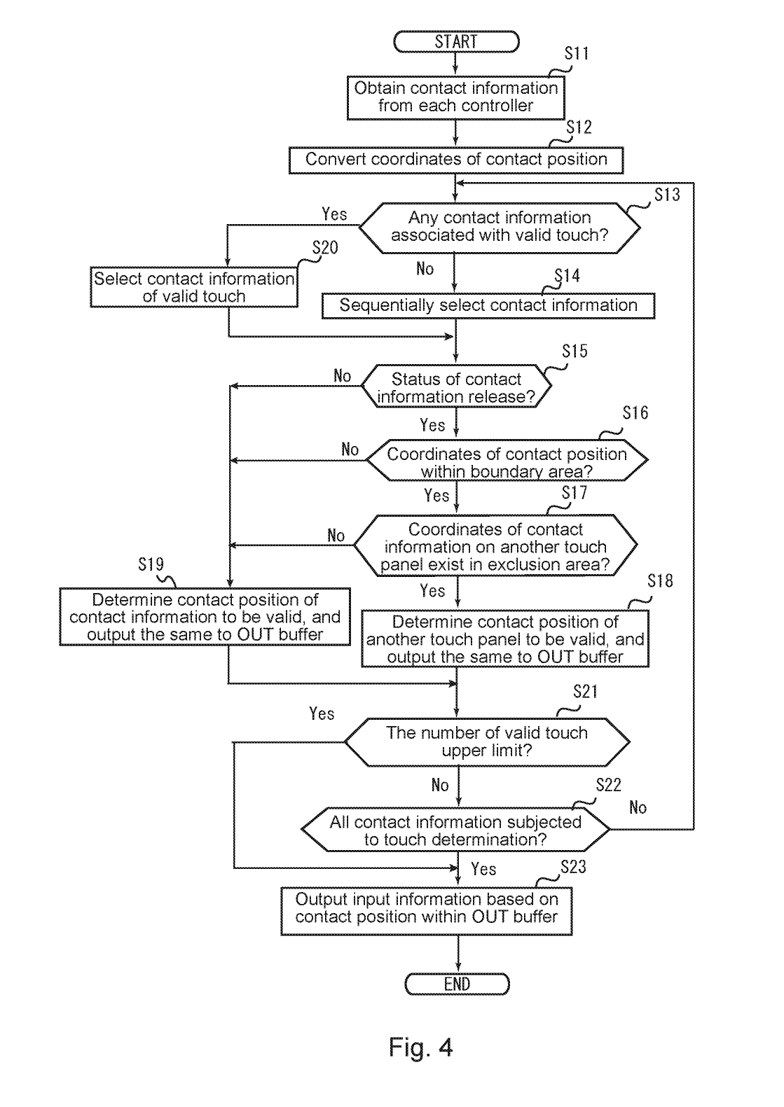

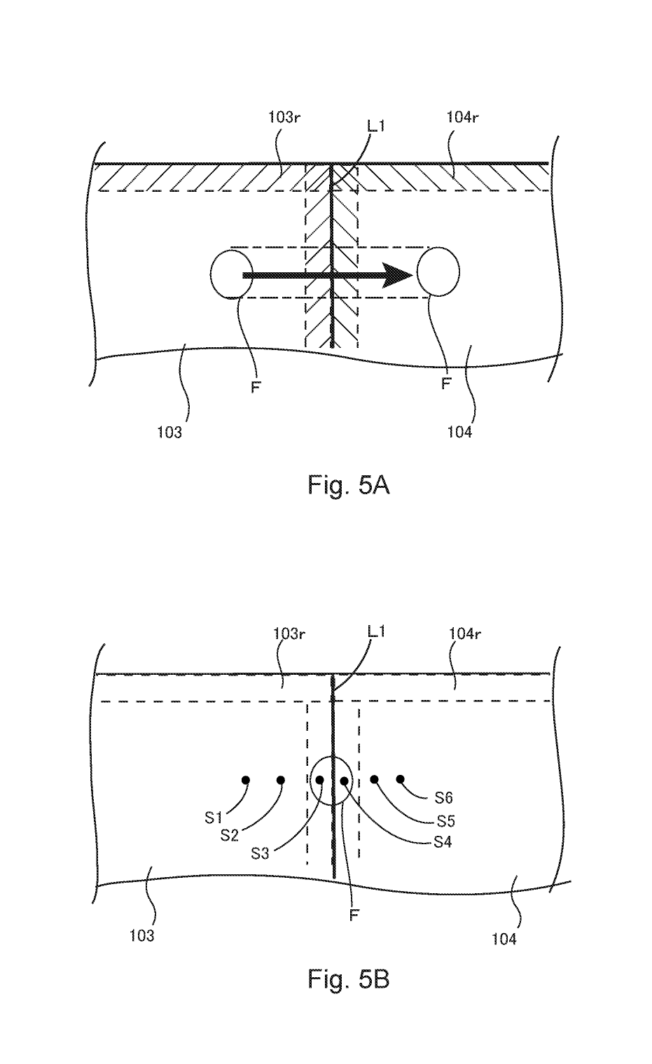

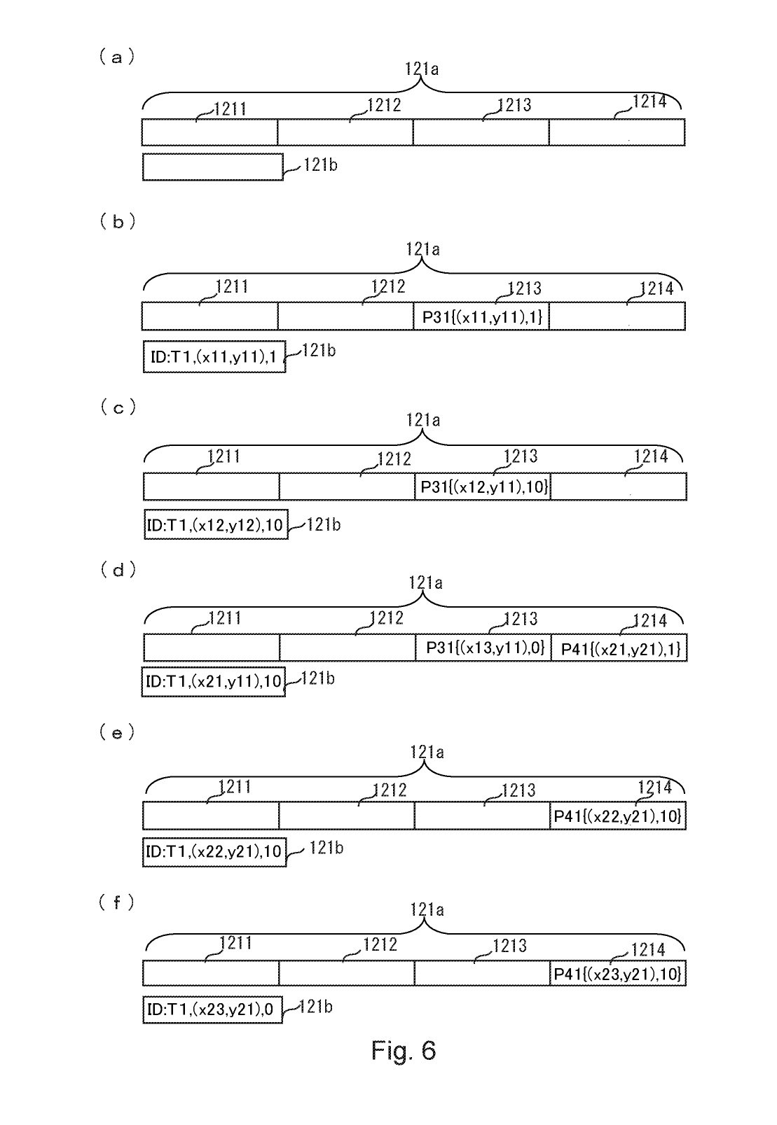

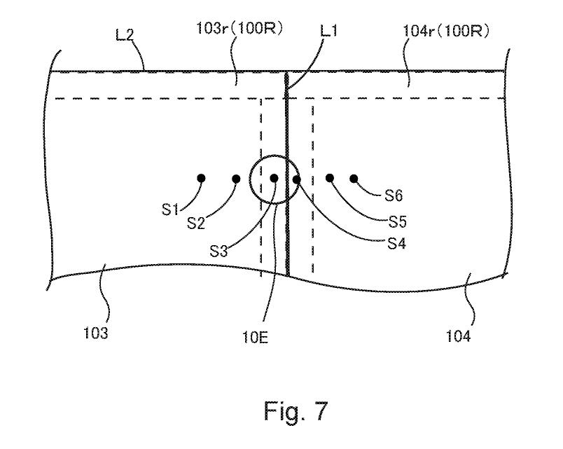

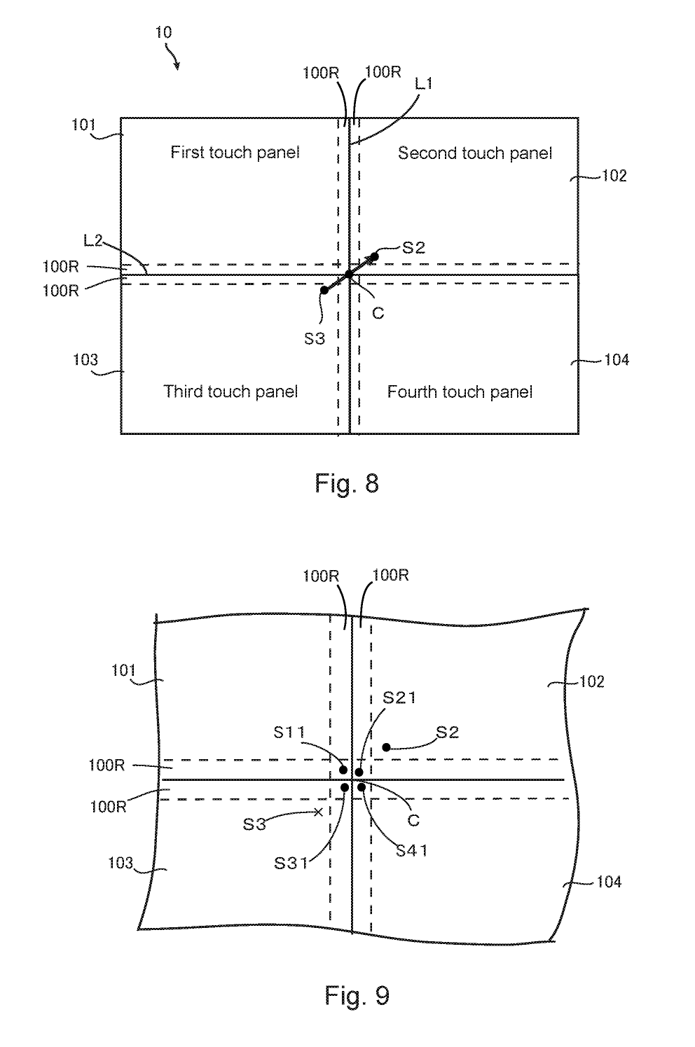

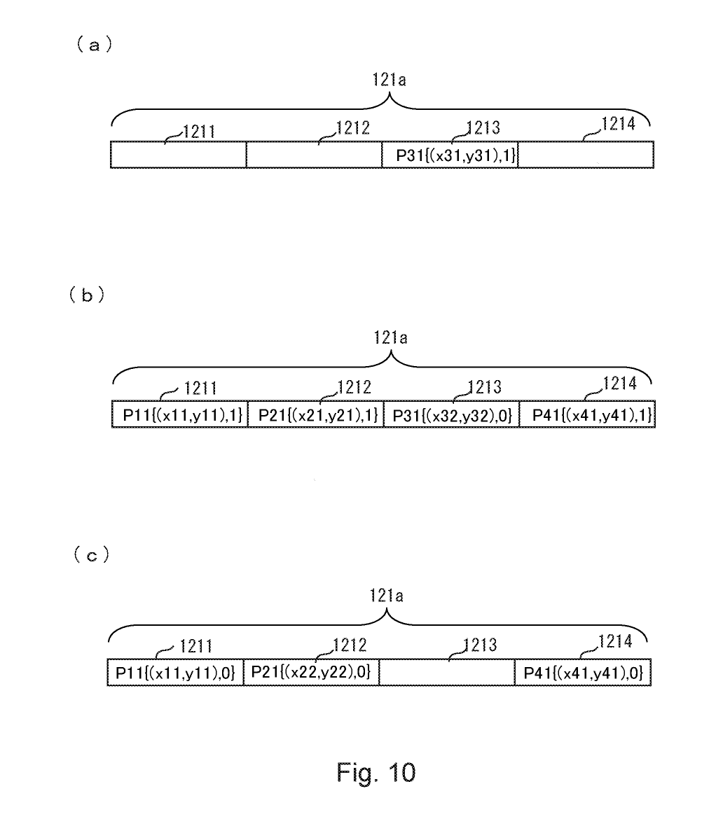

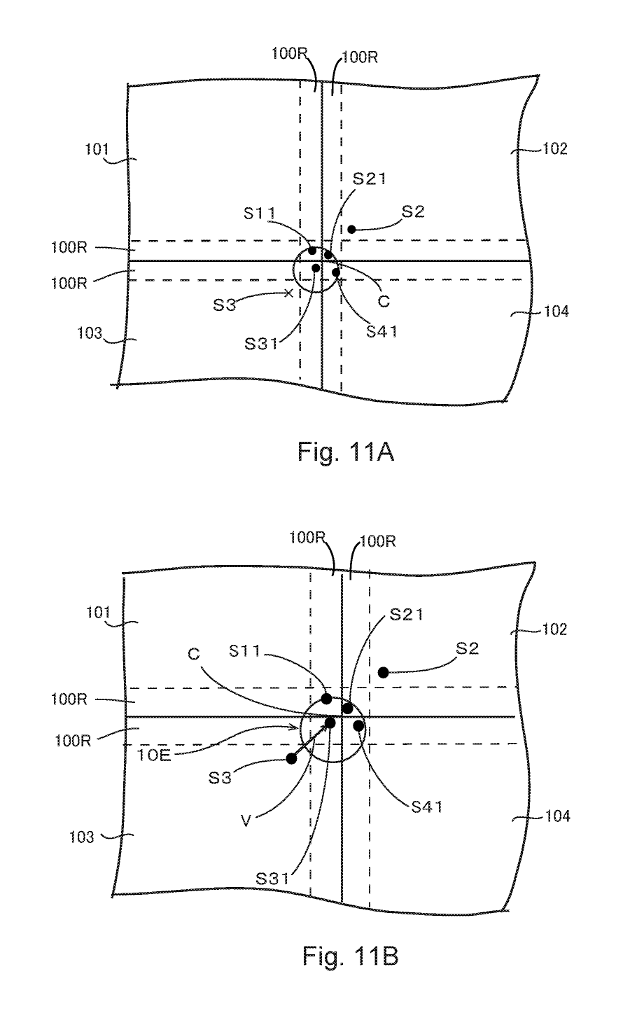

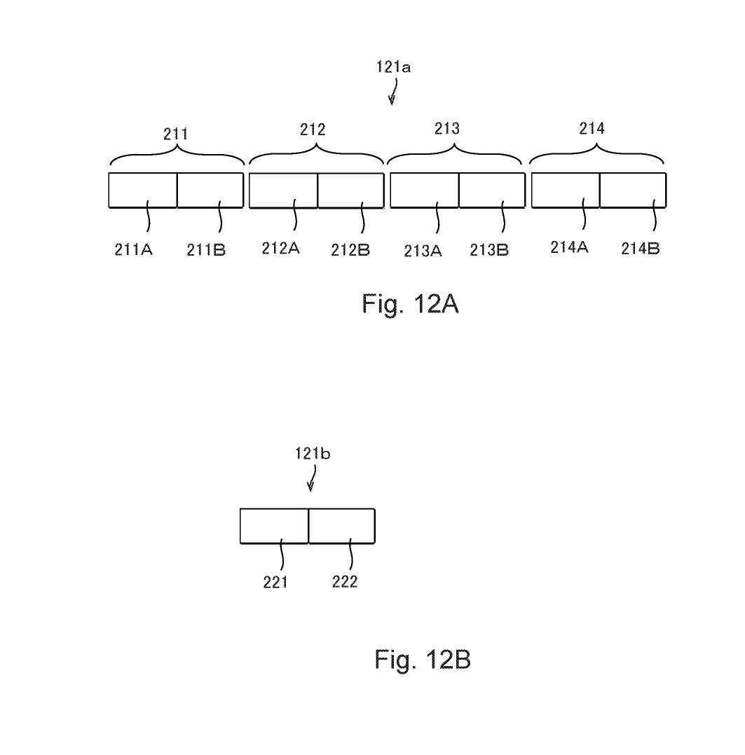

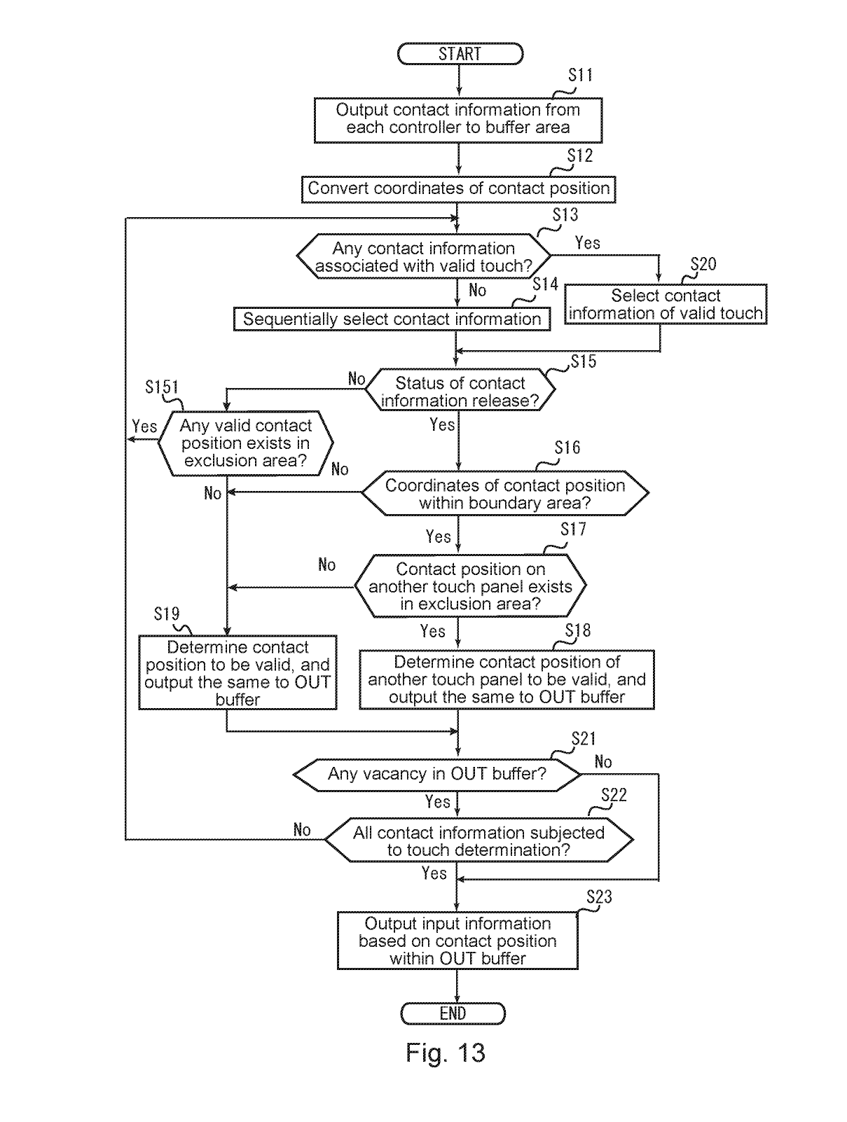

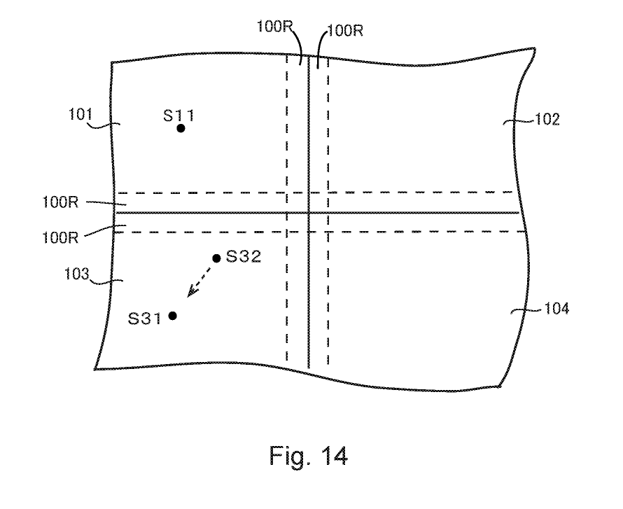

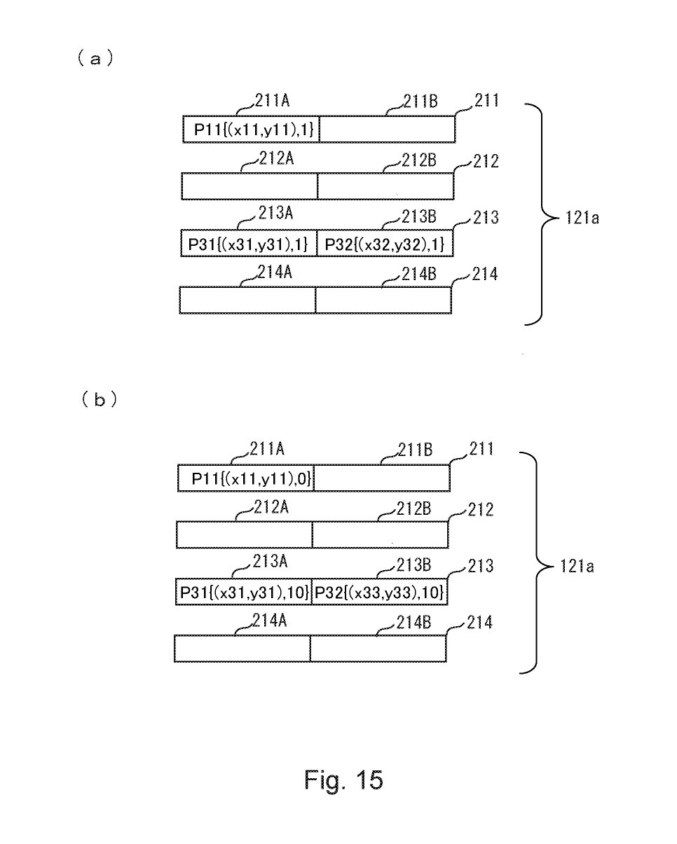

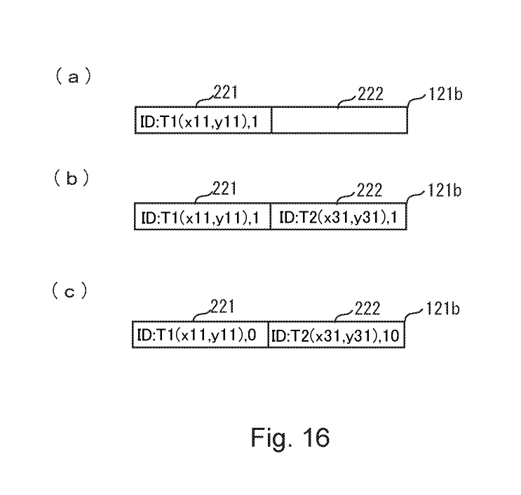

FIG. 5A is an image diagram in a case where an operation of sliding a finger on the touch panel illustrated in FIG. 3B.

FIG. 5B illustrates contact positions detected in the slide operation illustrated in FIG. 5A.

FIG. 6 illustrates examples of an IN buffer and an OUT buffer in the example of FIG. 5B.

FIG. 7 illustrates an exclusion area in the example of FIG. 5B.

FIG. 8 explains an exemplary input operation in Embodiment 2.

FIG. 9 illustrates a contact position detected by the exemplary input operation illustrated in FIG. 8.

FIG. 10 illustrates an exemplary IN buffer in the example of FIG. 9.

FIG. 11A illustrates an exclusion area in the example of FIG. 9.

FIG. 11B explains a vector direction at a release position in the example of FIG. 9.

FIG. 12A illustrates an exemplary configuration of an IN buffer in Embodiment 3.

FIG. 12B illustrates an exemplary configuration of an OUT buffer in Embodiment 3.

FIG. 13 is a flowchart illustrating an exemplary operation of an input device in Embodiment 3.

FIG. 14 illustrates exemplary contact positions in Embodiment 3.

FIG. 15 illustrates an exemplary IN buffer in the example of FIG. 14.

FIG. 16 illustrates an exemplary OUT buffer in the example of FIG. 14.

FIG. 17A illustrates a state of transition of one contact position in the example of FIG. 14.

FIG. 17B illustrates an exclusion area in the example of FIG. 17A.

FIG. 18 is a flowchart illustrating an exemplary operation of an input device in Embodiment 4.

FIG. 19A illustrates exemplary contact positions in Embodiment 4.

FIG. 19B illustrates exemplary contact positions in Embodiment 4.

### MODE FOR CARRYING OUT THE INVENTION

An input device according to one embodiment of the present invention includes: a contact detection unit including a plurality of touch panels arranged so as to adjacent to one another, the contact detection unit detecting, as to each of the touch panels, an input operation on the touch panel, and outputting contact information that contains a contact position on the touch panel corresponding to the input operation, and release detection information that indicates whether or not the contact position is a release position at which the contact with the touch panel stopped; a determination unit that determines an input position with respect to an entire surface of the plurality of touch panels, based on the contact position in the contact information output by the contact detection unit; and an output unit that outputs the contact position determined to be the input position, as a contact position associated with the input operation corresponding to the said contact position, the input operation being detected by the contact detection unit, wherein, in a case where the release detection information contained in the contact information for one of the touch panels indicates that the contact position is a release position, when a contact position on another touch panel exists in a predetermined area defined on the basis of the release position, the determination unit determines the contact position on the another touch panel to be the input position, and the output unit outputs the contact position on the another touch panel, which is determined to be the input position, as a contact position associated with the input operation corresponding to the release position on the one of the touch panels, the input operation being detected by the contact detection unit (the first configuration).

According to the first configuration, the contact detection unit in the input device detects an input operation as to each of a plurality of touch panels arranged so as to be adjacent to one another. The contact detection unit outputs contact information that contains a contact position on the touch panel corresponding to the detected input operation, and release information that indicates whether or not the contact position is a position at which the contact with the touch panel stopped. The input device, in the determination unit, determines an input position with respect to an entire surface of the plurality of touch panels, based on the contact position in the contact information output by the contact detection unit, and in the output unit, outputs the contact position determined to be the input position, as a contact position associated with the input operation corresponding to the said contact position. In a case where the release information contained in the contact information for one of the touch panels indicates that the contact position is a release position, when a contact position on another touch panel exists in a predetermined area defined on the basis of the release position, the determination unit determines the contact position on the another touch panel to be an input position, and the output unit outputs the contact position on the another touch panel, which is determined to be the input position, as a contact position associated with the input operation corresponding to the release position on the one of the touch panels.

In a case where, for example, an input operation of sliding along a boundary between adjacent touch panels is performed, a contact position by the input operation is detected on one of touch panels, and a contact position in the vicinities of the boundary is detected as a release position at which the contact on the one of the touch panels stopped. On another touch panel, in the vicinities of the boundary, a contact position of a new input operation is detected, independent of the input operation on the one of the touch panels. When the contact position on the another touch panel is included within a predetermined area defined on the basis of the release position on the one of the touch panels, the contact position on the another touch panel is determined to be an input position, the contact position on the another touch panel is output as a contact position associated with the input operation corresponding to the release position on the one of the touch panels. Therefore, the contact position on the another touch panel is treated, as a contact position associated with an input operation other than the input operation with respect to the one of the touch panels, but as a contact position associated with the input operation with respect to the one of the touch panels, whereby contents of the operation can be appropriately reflected.

The second configuration may be such that, in the first configuration, when the release position on the one of the touch panels is within a boundary area that includes a boundary with the another touch panel, in the touch panel that includes the release position, the determination unit determines whether or not the contact position on the another touch panel exists within the predetermined area.

According to the second configuration, only in the case where the release position is within the boundary area, the above-described determination is performed. Therefore, as compared with the case where the above-described determination is performed irrespective of whether the release position is within the boundary area, accuracy of detection of an input position between adjacent touch panels can be improved.

The third configuration may be such that, in the first or second configuration, the determination unit determines a contact position on the another touch panel that is located at the shortest distance to the release position on the one of the touch panels and exists within the predetermined area, to be the input position.

With the third configuration, the contact position on the another touch panel closest to the release position can be determined as the input position.

The fourth configuration may be such that, in the first or second configuration, the determination unit specifies a vector direction based on the release position on the one of the touch panels and another contact position on the one of the touch panels, and determines a contact position on the another touch panel positioned in the vector direction starting from the release position as a starting point, to be the input position.

With the fourth configuration, a contact position on the another touch panel according to transition of the contact on the one of the touch panels can be determined as an input position.

The fifth configuration may be such that, in any one of the second to fourth configurations, in a case where the release detection information contained in the contact information for the one of the touch panels indicates that the contact position is not a release position, when a contact position on another touch panel is included in a predetermined area that is within the boundary area in the touch panel including the contact position of the contact information and is defined on the basis of the contact position, the determination unit determines the contact position to be the input position, and the input device may further include a correction unit that corrects the contact position determined to be the input position, using the contact position on the another touch panel.

With the fifth configuration, in a case where a contact position within a boundary area on one of the touch panels is not a release position, if a contact position on another touch panel exists in a predetermined area defined on the basis of the contact position, the contact position on the one of the touch panels is assumed to be an input position, and the contact position is corrected by using the contact position on the another touch panel. Therefore, a contact position to which contents of an operation in a boundary area on the one of the touch panels are reflected can be output as an input position.

A control program according to one embodiment of the present invention is a control program for causing a computer of an input device that includes a plurality of touch panels arranged so as to be adjacent to one another to execute: a contact detection step of detecting, as to each of the touch panels, an input operation on the touch panel, and outputting contact information that contains a contact position on the touch panel corresponding to the input operation, and release detection information that indicates whether or not the contact position is a release position at which the contact with the touch panel stopped; a determination step of determining an input position with respect to an entire surface of the plurality of touch panels, based on the contact position in the contact information output by the contact detection step; and an output step of outputting the contact position determined to be the input position, as a contact position associated with the input operation corresponding to the said contact position, the input operation being detected in the contact detection step, wherein, in a case where the release detection information contained in the contact information for one of the touch panels indicates that the contact position is a release position, when a contact position on another touch panel exists within a predetermined area defined on the basis of the release position, the determination step determines the contact position on the another touch panel to be the input position, and the output step outputs the contact position on the another touch panel, which is determined to be the input position, as a contact position associated with the input operation corresponding to the release position on the one of the touch panels, the input operation being detected in the contact detection step (sixth configuration).

The following description describes embodiments of the present invention in detail while referring to the drawings. In the drawings, identical or equivalent parts are denoted by the same reference numerals, and descriptions of the same are not repeated.

### Embodiment 1

### Configuration

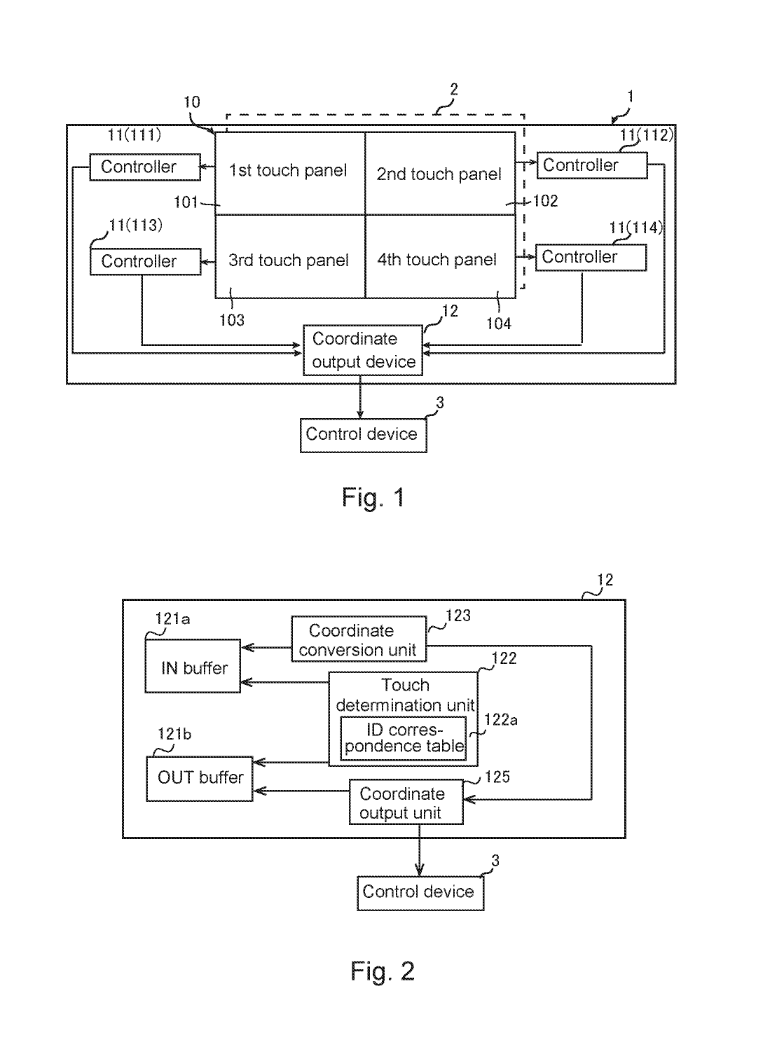

FIG. 1 is a block diagram illustrating a schematic configuration of an input device according to the present embodiment. The input device 1 includes a touch panel 10, controllers 11(111) to 11(114), and a coordinate output device 12. Hereinafter, when the controllers 11(111) to 11(114) are not distinguished particularly, they are referred to as the controllers 11. The input device 1 has such a configuration that the touch panel 10 is arranged on a display panel 2 such as a liquid crystal panel. The input device 1 is connected to a control device 3 provided outside the input device 1. The input device 1 outputs coordinates on the touch panel 10 to the control device 3, and an image according to the coordinates is displayed on the display panel 2 by the control device 3.

The touch panel 10 includes a first touch panel 101, a second touch panel 102, a third touch panel 103, and a fourth touch panel 104 that have respective sensing areas that are independent from one another. The first touch panel 101, the second touch panel 102, the third touch panel 103, and the fourth touch panel 104 are arranged so as to be adjacent to one another. Hereinafter, the first touch panel 101, the second touch panel 102, the third touch panel 103, and the fourth touch panel 104 are referred to as touch panels 100 when they are not distinguished particularly.

The touch panel 10 is provided on the display panel 2 in such a manner that the sensing areas of the first touch panel 101, the second touch panel 102, the third touch panel 103, and the fourth touch panel 104 entirely overlap the display region of the display panel 2.

The first touch panel 101 is connected with the controller 111, and the second touch panel 102 is connected with the controller 112. Likewise, the third touch panel 103 is connected with the controller 113, and the fourth touch panel 104 is connected with the controller 114.

The touch panels 100 are, for example, electrostatic capacitance touch panels. The touch panels 100 include a group of drive electrodes (not shown) and a group of sense electrodes (not shown) that are arranged in matrix. The sensing area of the touch panels 100 is formed with the drive electrode group and the sense electrode group.

In the touch panels 100, the drive electrode group is sequentially scanned by the control of the corresponding controllers 11, and a signal indicative of an electrostatic capacitance is output from the sense electrode group.

The controller 11 sequentially outputs a scanning signal to the corresponding drive electrode of the touch panels 100, and in a case where the signal value output from the sense electrode is equal to or more than a threshold value, contact of a finger is detected by the touch panels 100. Then, the controller 11 detects coordinates corresponding to the position at which the drive electrode and the sense electrode from which the signal value is obtained intersect, as a position of input (contact position). The coordinates of the contact position are coordinates on a coordinate plane that is preliminarily set in the touch panels 100. Further, in the present embodiment, the touch panels 100 are touch panels of a single touch system, and the controller 11 detects coordinates of one point in the corresponding touch panel 100.

Further, an input operation from when a finger comes into contact with the corresponding touch panel 100 until the finger leaves the same is assumed to be an operation unit, and the controller 11 detects a state of contact per input operation, together with a contact position. The state of contact is either one of a state in which a finger is brought into contact with the touch panels 100 for the first time, a state in which the finger continuously remains in contact with the touch panels 100, and a state in which the finger is separated from the touch panels 100.

The controller 11 outputs contact information that includes a contact position on the touch panels 100 per input operation, status information that indicates a state of contact, and controller information, to the coordinate output device 12. The status information contains either one of a touch start information that indicates the start of contact of a finger, hold information that indicates that the contact remains continuing, and release information that indicates that the finger has left the touch panels 100. The controller information contains a controller No. for identifying the controller 11, and a controller ID for identifying an input operation on the touch panels 100. Hereinafter, let the controller Nos. of the controllers 111, 112, 113, and 114 be P1, P2, P3, and P4, respectively.

For example, in a case where an operation of sliding a finger in a state where the finger is in contact with the touch panels 100 is performed, the controller 11 outputs contact information that contains coordinates of the position of the first contact of the finger, a flag of “1” indicating the touch start information, and controller information. The controller 11 outputs, for example, “P11” that contains a controller No. of “P1”, and a controller ID of “1”, as the controller information. Subsequently, the controller 11 outputs contact information that contains coordinates of the contact position while the finger is sliding, a flag of “10” indicating the hold information, and controller information of “P11”. Then, when the finger leaves the touch panels 100, the controller 11 outputs contact information that contains coordinates of the contact position when the finger leaves, a flag of “0” indicating release information, and controller information of “P11”. It should be noted that the above-described flags indicating the touch start information, the hold information, and the release information, respectively, the controller Nos., and the controller IDs are merely examples, and they may be any information that enables identification of touch panels, input operations, and contact states in the input operations.

The coordinate output device 12 includes a central processing unit (CPU), and memories (a read only memory (ROM) and a random access memory (RAM)), which are not illustrated in the drawings. FIG. 2 is a functional block diagram of the coordinate output device 12. The coordinate output device 12 executes a control program that the CPU stores in the ROM, thereby realizing the functions in the respective parts illustrated in FIG. 2, so as to specify an input position (coordinates) on a preliminarily set coordinate plane on the touch panel 10, based on the contact information output from each controller 11. Then, the coordinate output device 12 outputs input information containing the specified input position, to the control device 3. The following description describes each part of the coordinate output device 12.

In FIG. 2, the coordinate output device 12 includes an IN buffer 121a, an OUT buffer 121b, a touch determination unit 122, a coordinate conversion unit 123, and a coordinate output unit 125.

The IN buffer 121a includes buffer areas 1211 to 1214 (see FIG. 6) corresponding to the controllers 11 to 14, respectively. The IN buffer 121a stores contact information output from the controller 11 in the buffer area corresponding thereto. The OUT buffer 121b includes one buffer area, and stores therein valid contact information that contains a contact position that is determined to be valid by the touch determination unit 122.

The coordinate conversion unit 123 converts coordinates of each contact information stored in the IN buffer 121a into coordinates on a coordinate plane that is preliminarily set on the touch panel 10 (hereinafter the coordinates are referred to as “synthesized coordinates”), and stores the same in the RAM.

The touch determination unit 122 includes an ID correspondence table 122a. The ID correspondence table 122a stores controller information and IDs for identifying input operations on the touch panel 10, in correspondence with each other.

The touch determination unit 122 refers to the ID correspondence table 122a every predetermined time, and performs an operation of determining whether or not a contact position of contact information selected from the contact information stored in the IN buffer 121a is a contact position of a valid input operation (hereinafter such a contact position is referred to as a valid contact position) on the touch panel 10 (hereinafter this operation is referred to as a touch determination operation). The valid contact position is a contact position that is output to the control device 3, and in the present embodiment, the upper limit number of times when a valid contact position can be output to the control device 3 every predetermined time is set to “1”.

In a case where, in the touch determination operation, controller information corresponding to the contact position that is determined to be valid at a previous time is contained in the selected contact information, the touch determination unit 122 updates the valid contact information in the OUT buffer 121b based on the foregoing contact information.

In a case where the controller information corresponding to the contact position that is determined to be valid at a previous time is not contained in the selected contact information, the touch determination unit 122, when release information is not contained in the contact information, determines that the contact position of the foregoing contact information is valid as an input position on the touch panel 10. On the other hand, in a case where release information is contained in the selected contact information, the touch determination unit 122 determines whether or not the contact position of the contact information is present within a predetermined area in the touch panels 100 corresponding to the controller No. contained in the foregoing contact information. Here, the predetermined area is described by using FIG. 3A.

FIG. 3A is a schematic diagram illustrating the touch panel 10 shown in FIG. 1. The predetermined area is, in the touch panels 100, an area 100R between a boundary L1 and a broken line that is approximately parallel to the boundary L1 and is apart from the boundary L1 at a uniform distance in an X-axis positive or negative direction, and an area 100R between a boundary L2 and a broken line that is approximately parallel to the boundary L2 and is apart from the boundary L2 at a uniform distance in a Y-axis positive or negative direction. The boundary L1 is a boundary between the first touch panel 101 and the second touch panel 102, and between the third touch panel 103 and the fourth touch panel 104. The boundary L2 is a boundary between the first touch panel 101 and the third touch panel 103, and between the second touch panel 102 and the fourth touch panel 104. In other words, the predetermined area in the touch panels 100 is an area in the vicinities of boundaries between the adjacent touch panels 100, containing the boundaries. Hereinafter, the predetermined area is referred to as the boundary area.

For example, as illustrated in FIG. 3B, therefore, in the third touch panel 103, an area 103r(100R) that contains the boundary L1, which is a boundary between the same and the fourth touch panel 104 adjacent thereto, and the boundary L2, which is a boundary between the same and the first touch panel 101 adjacent thereto, is the boundary area. Further, in the fourth touch panel 104, an area 104r(100R) that contains the boundary L1, which is a boundary between the same and the third touch panel 103 adjacent thereto, and the boundary L2, which is a boundary between the same and the second touch panel 102 adjacent thereto, is the boundary area. Ranges of coordinates of the boundary areas in the respective touch panels 100 are stored in the ROM preliminarily.

The following description is made with reference to FIG. 2 again. In a case where coordinates in contact information containing the release information (hereinafter referred to as a release position) are outside the boundary area, the touch determination unit 122 determines that the release position is valid as an input position on the touch panel 10.

In a case where a release position is inside the boundary area, the touch determination unit 122 determines whether or not a contact position on another touch panel 100 exists in an area defined on the basis of the release position. In other words, the touch determination unit 122 determines whether or not, on the coordinate plane of the touch panel 10, synthesized coordinates corresponding to a contact position on the another touch panel 100 exist in an area defined on the basis of synthesized coordinates corresponding to the release position. Hereinafter, this area is referred to as an exclusion area.

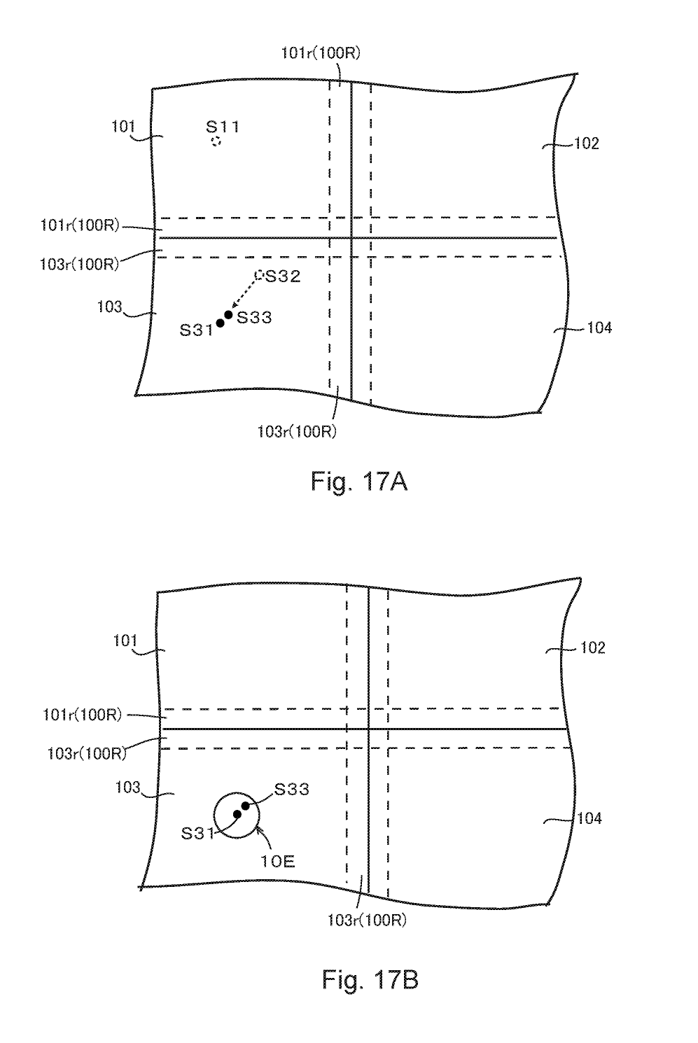

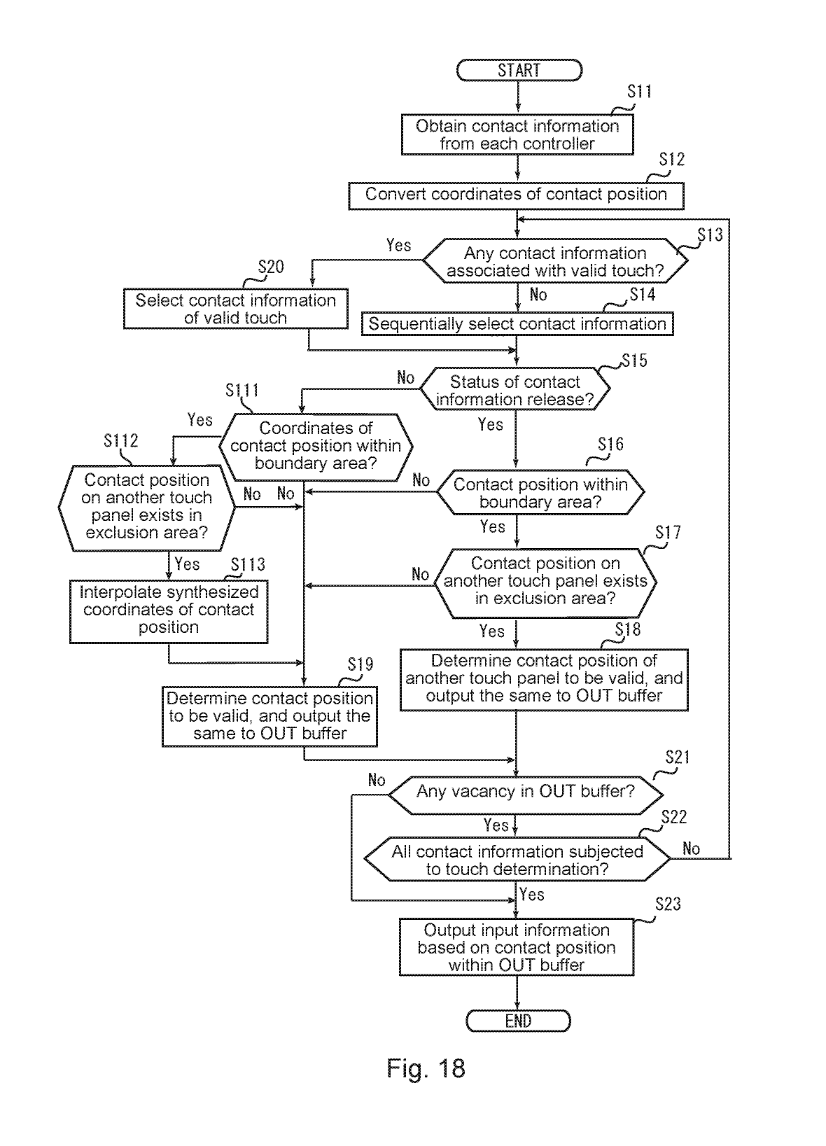

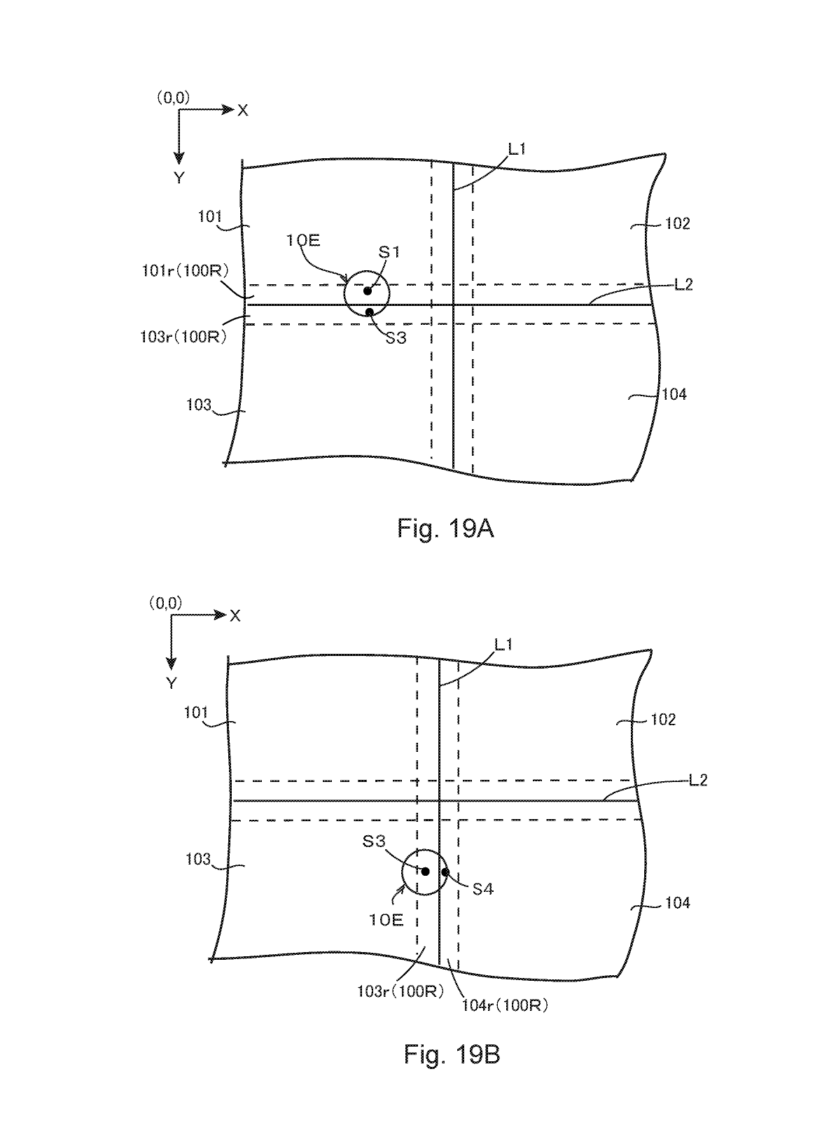

Here, the following description describes the exclusion area. For example, as illustrated in FIG. 30, an area 10E in a circle shape having a uniform radius around synthesized coordinates corresponding to a contact position S in the third touch panel 103 as the center thereof is set as an exclusion area. Desirably, the exclusion area 10E is, for example, approximately in a size of the finger cushion of the forefinger, but the size of the exclusion area is not limited to this. In a case where no contact position on another touch panel 100 exists within the exclusion area, the touch determination unit 122 determines the release position to be valid as the input position on the touch panel 10. Further, in a case where a contact position on another touch panel 100 exists within the exclusion area, the touch determination unit 122 determines the contact position on the another touch panel 100 to be valid.

The following description refers to FIG. 2 again. The touch determination unit 122 inputs, to the OUT buffer 121b, valid contact information containing the contact position of the contact information that is determined to be valid, an ID, and the status information contained in the contact information. Further, the touch determination unit 122 stores the controller information contained in the contact information that is determined to be valid, and the ID applied, in correspondence with each other, in the ID correspondence table 122a.

The coordinate output unit 125 outputs input information based on the valid contact information stored in the OUT buffer 121b, to the control device 3.

### Operation Example

Next, an operation example of the input device 1 according to the present embodiment is described. FIG. 4 illustrates an operation flow of the input device 1.

Each controller 11 outputs the detected contact information to the IN buffer 121a in the coordinate output device 12 (Step S11).

The coordinate output device 12 converts the coordinates of the contact information stored in the IN buffer 121a, into synthesized coordinates on the coordinate plane of the touch panel 10 (Step S12).

The coordinate output device 12 refers to the IN buffer 121a every predetermined time, and determines whether or not contact information associated with the valid touch is stored in the IN buffer 121a (Step S13). In other words, the coordinate output device 12 determines whether or not contact information containing the controller information corresponding to the valid contact information stored in the OUT buffer 121b at a previous time is stored in the IN buffer 121a. In a case where the contact information containing the controller information corresponding to the valid contact information stored in the OUT buffer 121b at a previous time is not stored in the IN buffer 121a (Step S13: No), the coordinate output device 12 sequentially selects the contact information stored in the IN buffer 121a (Step S14).

Subsequently, in a case where release information is contained in the selected contact information (Step S15: Yes), the coordinate output device 12 determines whether or not the contact position of the contact information, that is, the release position, is within a boundary area (Step S16).

In a case where the release position is within the boundary area (Step S16: Yes), the coordinate output device 12 determines whether or not a contact position on another touch panel exists in an exclusion area defined on the basis of the release position (Step S17). In other words, the coordinate output device 12 determines whether or not contact information containing a contact position corresponding to synthesized coordinates within the exclusion area is stored in the IN buffer 121a.

In a case where a contact position on another touch panel exists within the exclusion area defined on the basis of the release position (Step S17: Yes), the coordinate output device 12 assumes the contact position on the another touch panel to be valid, and stores valid contact information containing the contact position in the OUT buffer 121a (Step S18).

In a case of “No” in Steps S15, S16, and S17, the coordinate output device 12 assumes the contact position of the selected contact information to be valid, and stores contact information containing the contact position in the OUT buffer 121a (Step S19).

Further, in a case where, in Step S13, contact information containing the controller information corresponding to the ID of the valid contact information stored in the OUT buffer 121b at a previous time is stored in the IN buffer 121a (Step S13: Yes), the coordinate output device 12 updates the valid contact information stored in the OUT buffer 121b based on the contact information (Step S20).

Here, a touch determination operation in a case, for example, as illustrated in FIG. 5A, a finger F is slid from the third touch panel 103 over the boundary L1 to the fourth touch panel 104 is described.

In a case where, as illustrated in FIG. 5A, the finger F is slid from the third touch panel 103, over the boundary L1, to the fourth touch panel 104, it is assumed that, as illustrated in FIG. 5B, points S1, S2, and S3 on the third touch panel 103 are sequentially detected as contact positions by the controller 113 at fixed time intervals, and points S4, S5, and S6 on the fourth touch panel 104 are sequentially detected as contact positions by the controller 114. When the finger F passes over the boundary L1, the contact position S3 and the contact position S4 are detected approximately simultaneously.

FIG. 6 schematically illustrates information stored in the IN buffer 121a and the OUT buffer 121b in the present example in time series. (a) of FIG. 6 illustrates the IN buffer 121a and the OUT buffer 121b in a state in which the finger F does not touch any of the touch panels 100 in FIG. 5B.

When a contact position S1 at which the finger F touches the third touch panel 103 for the first time is detected, contact information indicating the contact position S1 is output by the controller 113. Consequently, as illustrated in (b) of FIG. 6, contact information of “P31{(x11, y11), 1}”, which contains controller information of “P31”, coordinates of (x11, y11) on the third touch panel 103 corresponding to the contact position S1, and touch start information of “1”, is stored in the buffer area 1213, and the coordinates of (x11, y11) are converted to synthesized coordinates on the predetermined coordinate plane (Steps S11 and S12 in FIG. 4).

At a point of time when the contact position S1 is detected, valid contact information at a previous time is not stored in the OUT buffer 121b, and hence, the contact information of “P31{(x11, y11), 1}” is selected (Step S13: No, S14 in FIG. 4). Since touch start information of “1” is contained in this contact information, as illustrated in (b) in FIG. 6, valid contact information containing the coordinates of (x11, y11), a new ID of T1, and the touch start information of “1” is stored in the OUT buffer 121b (Step S19 in FIG. 4). Further, in the ID correspondence table 122a, the ID of “T1” and the controller information of “P31” are stored in correspondence with each other.

Next, when a contact position S2 (see FIG. 5B) is detected in the third touch panel 103, contact information for the contact position S2 is output from the controller 113. Consequently, the buffer area 1213 is updated to a state illustrated in (c) of FIG. 6. In other words, contact information of “P31{(x12, y11), 10}” containing the controller information of “P31” of the controller 113, coordinates of (x12, y11) on the third touch panel 103 corresponding to the contact position S2, and hold information of “10” is stored in the buffer area 1213. An ID corresponding to this controller information for the contact information is “T1”, and valid contact information in the OUT buffer 121b illustrated in (b) of FIG. 6 contains the ID of “T1”. As illustrated in (c) of FIG. 6, therefore, valid contact information containing this contact position of the contact information, as well as the same ID of “T1” and the hold information as those at the previous time, is stored in the OUT buffer 121b (Step S13: Yes, Steps S20, S15: No, S19 in FIG. 4).

Subsequently, a contact position S3 when the finger F passes over the boundary L1 in FIG. 5B, in other words, when the finger F leaves the third touch panel 103, is detected, and contact information for the contact position S3 is output from the controller 113. Further, a contact position S4 when the finger F touches the fourth touch panel 104 for the first time is detected, and contact information for the contact position S4 is output from the controller 114. Consequently, the buffer area 1213 and the buffer area 1214 are updated to a state illustrated in (d) of FIG. 6. In other words, contact information of “P31{(x13, y11), 0}” containing the controller information of “P31”, coordinates of (x13, y11) on the third touch panel 103 corresponding to the contact position S3, and release information of “0” is stored in the buffer area 1213. Further, contact information of “P41{(x21, y21), 1}” containing controller information of “P41”, coordinates of (x21, y21) on the fourth touch panel 104 corresponding to the contact position S4, and touch start information of “1” is stored in the buffer area 1214.

Since an ID corresponding to controller information of “P31” of contact information in the buffer area 1213 is “T1” and the valid contact information in the OUT buffer 121b illustrated in (d) of FIG. 6 contains the ID of T1, this contact information is selected first (Step S13: Yes, S20 in FIG. 4). Since this contact information contains release information, it is determined whether the contact position S3 is within a boundary area 103r in the third touch panel 103 (FIG. 5B) (Step S13: Yes, Steps S20, S15: Yes, S16 in FIG. 4). In this example, the contact position (x13, y11) is included in a coordinate range corresponding to the boundary area 103r. It is therefore determined whether or not a contact position on another touch panel 100 exists within the exclusion area defined on the basis of this contact position (Step S16: Yes, S17 in FIG. 4).

The exclusion area defined on the basis of the contact position S3 is a circular area 10E having a uniform radius around the contact position S3 as the center thereof, as illustrated in FIG. 7. The coordinate output device 12 sets the exclusion area 10E having a uniform radius around synthesized coordinates corresponding to the coordinate (x13, y11) as the center, on the coordinate plane of the touch panel 10. In this example, since the contact position S4 of the fourth touch panel 104 exists in a coordinate range of the exclusion area 10E, the contact position in the contact information for the fourth touch panel 104 is assumed to be valid (Step S17: Yes, S18 in FIG. 4). Consequently, the OUT buffer 121b is updated to the state illustrated in (d) of FIG. 6. In other words, as illustrated in (d) of FIG. 6, valid contact information containing the coordinates of the contact position S4, the same ID of “T1” as the ID stored in the OUT buffer 121b at a previous time, and the hold information of “10” is stored in the OUT buffer 121b. Besides, controller information of “P41” corresponding to the contact position S4 and the ID of “T1” are stored in correspondence with each other in the ID correspondence table 122a.

Subsequently, in FIG. 5B, the contact position S5 is detected in the fourth touch panel 104, and contact information for the contact position S5 is output from the controller 114. Consequently, the buffer area 1213 and the buffer area 1214 are updated to the state illustrated in (e) of FIG. 6. In other words, no contact information is stored in the buffer area 1213, and contact information of “P41{(x22, y21), 10}” containing controller information of “P41”, coordinates of (x22, y21) on the fourth touch panel 104 corresponding to the contact position S5, and hold information (=10) is stored in the buffer area 1214. An ID corresponding to controller information of “P41” of this contact information is T1, and the ID of “T1” is contained in valid contact information in the OUT buffer 121b illustrated in (d) of FIG. 6. In the OUT buffer 121b, therefore, valid contact information containing coordinates of this contact position S5, the same ID of “T1” and the same hold information as those at the previous time is stored, as illustrated in (e) of FIG. 6 (Step S13: Yes, Steps S20, S15: No, S19 in FIG. 4). As a result, in the touch panel 10, the contact position S5 is treated as a contact position associated with an input operation corresponding to the contact position S1.

Next, the contact position S6 when the finger F leaves from the fourth touch panel 104 is detected, and contact information for the contact position S6 is output from the controller 114. Consequently, the buffer area 1214 is updated to a state illustrated in (f) of FIG. 6. In other words, contact information of “P41{(x23, y21), 0}” containing controller information of “P41”, coordinates of (x23, y21) on the fourth touch panel 104 corresponding to the contact position S6, and release information (=0) is stored in the buffer area 1214. An ID corresponding to the controller information of “P41” of the contact information is T1, and the ID of “T1” is contained in valid contact information in the OUT buffer 121b illustrated in (e) of FIG. 6. Release information is included in this contact information, and the contact position S6 is out of the boundary area 104R in the fourth touch panel 104. As illustrated in (f) of FIG. 6, therefore, valid contact information containing coordinates of this contact position S6 as well as the same ID of “T1” and the same release information as those at the previous time is stored in the OUT buffer 121b (Step S13: Yes, Steps S20, S15: Yes, Step S16: No, S19 in FIG. 4). Through the above-described processing, the contact positions S4, S5, and S6 are treated as contact positions associated with an input operation corresponding to the contact position S1.

The following description refers to FIG. 4 again. In a case where the number of valid touches is less than the upper limit, in other words, in a case where the number of valid contact positions stored in the OUT buffer 121b is less than the upper limit of the number of those that can be output to the control device 3 (Step S21: No), if all of the pieces of contact information in the IN buffer 121a have not been subjected to the processing operation in Steps S13 to 20 (touch determination operation) (Step S22: No), the coordinate output device 12 repeats the processing operation after Step S13. Further, in a case where the number of valid touches is equal to the upper limit (Step S21: Yes), the coordinate output device 12 reads, from the RAM, synthesized coordinates corresponding to the contact position contained in the valid contact information stored in the OUT buffer 121b, and outputs input information containing the synthesized coordinates as well as the ID and status information contained in the valid contact information, to the control device 3 (Step S23).

In a case where an operation of drawing a line over a boundary between adjacent ones of the touch panels 100 by sliding a finger is performed, the touch of the finger is assumed to leave, in the detection in the vicinities of the boundary of one of the adjacent touch panels 100. In contrast, on the other touch panel 100, though the input operation is an input operation continuous to the input operation on the foregoing one touch panel 100, the contact position is detected as a position of contact in a new input operation. In Embodiment 1 mentioned above, in a case where the release position is within a boundary area in one of adjacent touch panels 100, if a contact position on another touch panel 100 exists in an exclusion area defined on the basis of the release position, the contact position on the another touch panel 100 is assumed to be valid, and valid contact information containing the contact position assumed to be valid, as well as the same ID and the same hold information as those of a contact position assumed to be valid at a previous time, is stored in the OUT buffer 121b. The contact position detected on the foregoing another touch panel 100, therefore, is treated as a contact position associated with the input operation on the foregoing one of the touch panels 100 by the control device 3, and hence, a line can be drawn on the display panel 2, without any break at the boundary.

### Embodiment 2

In the description of Embodiment 1 above, an example is described in which, in an exclusion area defined on the basis of a release position in one of adjacent touch panels 100, only one contact position on another touch panel 100 exists. In the description of the present embodiment, an example is described in which in an exclusion area, a plurality of contact positions on the another touch panel 100 are included.

For example, as illustrated in FIG. 8, in a case where an operation of sliding a finger from a position of S3 on the third touch panel 103, through a point of intersection C at which the first touch panel 101 to the fourth touch panel 104 are in contact with one another, to a position of S2 on the second touch panel 102 is performed, when the finger passes through the point of intersection C, the finger is brought into contact with the first touch panel 101 to the fourth touch panel 104. In this case, as illustrated in FIG. 9, contact positions S11, S21, S31, and S41 are sequentially detected at fixed time intervals each of the boundary areas 100R in the first touch panel 101 to the fourth touch panel 104.

Consequently, as illustrated in (a) of FIG. 10, contact information of “P31{(x31, y31), 1}” of the contact position S3, which is output from the controller 113, is stored in the buffer area 1213 first. When the finger passes through the point of intersection C, as illustrated in (b) of FIG. 10, pieces of contact information of “P11{(x11, y11), 1}”, “P21{(x21, y21), 1}”, “P31{(x32, y32), 0}”, and “P41{(x41, y41), 1}” are stored in the buffer areas 1211 to 1214, respectively.

The contact information of “P31{(x32, y32), 0}” in the buffer area 1213, illustrated in (b) of FIG. 10, is contact information output from the controller 113. The coordinates of (x32, y32) correspond to the contact position S31, and indicate a release position when the finger leaves the third touch panel 103.

The contact information of “P11{(x11, y11), 1}” in the buffer area 1211 in (b) of FIG. 10 is contact information output from the controller 111. The coordinates of (x11, y11) correspond to the contact position S11, and indicate a position at which the finger touches the first touch panel 101 for the first time.

The contact information of “P21{(x21, y21), 1}” in the buffer area 1212 in (b) of FIG. 10 is contact information output from the controller 112. The coordinates of (x21, y21) correspond to the contact position S21, and indicate a position at which the finger touches the second touch panel 102 for the first time.

The contact information of “P41{(x41, y41), 1} in the buffer area 1214 in (b) of FIG. 10 is contact information output from the controller 114. The coordinates of (x41, y41) correspond to the contact position S41, and indicate a position at which the finger touches the fourth touch panel 104 for the first time.

Thereafter, as the finger moves to the second touch panel 102 and leaves the second touch panel 102, “P11{(x11, y11), 0}” is stored in the buffer area 1211, contact information of “P21{(x22, y22), 0}” is stored in the buffer area 1212, and “P41{(x41, y41), 0}” is stored in the buffer area 1214, as illustrated in (c) of FIG. 10. Coordinates of (x22, y22) correspond to the contact position S2, and indicate a release position at which the finger leaves the second touch panel 102.

As is the case with Embodiment 1 described above, the coordinate output device 12 performs a touch determination operation with respect to the contact information of “P31{(x31, y31), 1}” illustrated in (a) of FIG. 10. This causes the contact position S31 to be assumed to be valid, and to be stored in the OUT buffer 121b.

Subsequently, the coordinate output device 12 performs a touch determination operation in the same manner as that of Embodiment 1 described above, selects the contact information of “P31{(x32, y32), 0} in (b) of FIG. 10, and performs a processing operation at Steps S15, S16 in FIG. 4 with respect to the contact information of “P31{(x32, y32), 0}”. In a case where contact information containing coordinates on another touch panel exists in a coordinate range of an exclusion area defined on the basis of the coordinates of (x32, y32) (Step S17: Yes), and further in a case where a plurality of pieces of contact information containing coordinates of the another touch panel, the coordinate output device 12 assumes one of the pieces of contact information that satisfies predetermined conditions to be valid.

In this example, as illustrated in FIG. 11A, the contact positions S11, S21, and S41 on the another touch panel 100 are included in the exclusion area 10E having coordinates of (x32, y32) corresponding to the contact position S31 as the center thereof. The coordinate output device 12 assumes, among the pieces of contact information illustrated in (b) of FIG. 10, the contact position positioned at the shortest distance to the contact position S31 to be valid, and assumes the other contact positions to be invalid. In other words, the coordinate output device 12 assumes, among the synthesized coordinates respectively corresponding to the contact positions S11, S21, and S41, the contact position with the synthesized coordinates at the shortest distance to the synthesized coordinates corresponding to the center of exclusion area 10E, i.e., (x32, y32) to be valid. In this example, the contact position S21 closest to the contact position S31 as the release position is assumed to be valid, and the contact positions S11 and S41 are assumed to be invalid.

As is the case with Step S20 described above, the coordinate output device 12 inputs, to the OUT buffer 121b, valid contact information that contains the coordinates of (x21, y21) of the contact position S21 assumed to be valid, the same ID as that of the contact position S3 input at the previous time, and hold information.

In the above-described example, among the contact positions on the another touch panel 100 in the exclusion area, the contact position at the shortest distance from the center of the exclusion area is assumed to be valid, but alternatively, a contact position positioned in the finger sliding direction from the center of the exclusion area may be assumed to be valid. The finger sliding direction is a direction with a vector V from the contact position S3 toward the contact position S31, as illustrated in FIG. 11B.

The coordinate output device 12 determines a vector V that connects synthesized coordinates corresponding to the contact position S3, detected before the contact position S31, and synthesized coordinates corresponding to the contact position S31; then, selects synthesized coordinates corresponding to the contact position S21 located approximately in the same direction as that of the vector V, in the exclusion area 10E. The coordinate output device 12 outputs, to the control device 3, input information that contains the selected synthesized coordinates of the contact position S21, the same ID as that of the contact position S3 input to the OUT buffer 121b at the previous time, and hold information. Thereby, synthesized coordinates in accordance with the locus of the contact position are output to the control device 3.

### Embodiment 3

In the description of Embodiment 1 above, an example is described in which the first touch panel 101 to the fourth touch panel 104 are touch panels of a single touch system for detecting one contact position, and one set of synthesized coordinates is output as an input position to the control device 3. In the description of the present embodiment, an example is described in which at fixed time intervals, first touch panel 101 to fourth touch panel 104 are touch panels of a multi-touch system that detect contact positions corresponding to a plurality of input operations, and output a plurality of sets of synthesized coordinates as input positions that can be output to the control device 3.

The following description refers to an exemplary case where the number of contact positions corresponding to an input operation detectable at fixed time intervals is set to “2” in each controller 11, and the upper limit of the number of input positions that can be output to the control device 3 is set to “2”.

FIG. 12A is a schematic diagram illustrating an example of an IN buffer 121a of the present embodiment. As illustrated in FIG. 12A, the IN buffer 121a has buffer areas 211, 212, 213, 214 that correspond to the first to fourth touch panels 101 to 104, respectively. Each buffer area includes two areas, and stores contact information corresponding to an input operation detected in each touch panel 100 in each area.

Further, FIG. 12B is a schematic diagram illustrating an example of an OUT buffer 121b of the present embodiment. As illustrated in FIG. 12B, the OUT buffer 121b includes two buffer areas 221 and 222. The OUT buffer 121b stores, in the buffer areas, sets of coordinates of two pieces of contact information that are determined to be valid among the pieces of contact information stored in the IN buffer 121a, respectively, as well as valid contact information containing IDs and status information.

FIG. 13 is an operation flow illustrating an exemplary operation of the input device 1 in the present embodiment. Each controller 11 outputs contact information detected in the touch panel 100 corresponding thereto, to the buffer area of the IN buffer 121a corresponding to each controller 113 (Step S11).

For example, as illustrated in FIG. 14, in a case where a contact position S11 on the first touch panel 101 and contact positions S31 and S32 on the third touch panel 103 are detected, each piece of contact information thereof are stored in the IN buffer 121a illustrated in FIG. 12A.

In other words, as illustrated in (a) of FIG. 15, contact information of “P11{(x11, y11),1}” corresponding to the contact position S11 is stored in the buffer area 211, and contact information of “P31{(x31, y31),1}” and “P32{(x32, y32),1}” corresponding to the contact positions S31 and S32, respectively, is stored in the buffer area 213. The controller information of “P11” in the contact information of “P11{(x11, y11),1}” contains the controller No. of “P1” and the controller ID of “1”. The controller information of “P31” in the contact information of “P31{(x31, y31),1}” contains the controller No. of “P3” and the controller ID of “1”. The controller information of “P32” in the contact information of “P32{(x32, y32),1}” contains the controller No. of “P3” and the controller ID of “2”.

The coordinate output device 12 converts each set of coordinates of the contact information stored in the IN buffer 121a, into synthesized coordinates (Step S12).

In a case where contact information associated with valid contact information stored in the OUT buffer 121b at a previous time is not stored in the IN buffer 121a (Step S13: No), the coordinate output device 12 selects pieces of contact information of the touch panels in a preliminarily set order. In the present embodiment, the coordinate output device 12, for example, selects contact information stored in the buffer areas corresponding to the first touch panel 101, the second touch panel 102, the third touch panel 103, and the fourth touch panel 104, respectively, in the stated order at a predetermined time.

In the example illustrated in (a) of FIG. 15, no valid contact information at a previous time is stored in the OUT buffer 121a. The contact information of “P11{(x11, y11),1}” stored in the buffer area 211, therefore, is selected first. Since no release information is included in this contact information of “P11{(x11, y11),1}” (Step S15: No, Step S16: No), the coordinate output device 12 shifts to an operation at Step S151.

At Step S151, the coordinate output device 12 sets a coordinate range of an exclusion area defined on the basis of the coordinates (x11, y11) in the contact information of “P11{(x11, y11),1}”, and determines whether or not any contact position associated with the valid contact information at the previous time exists in the coordinate range of the exclusion area. In other words, the coordinate output device 12 determines whether or not there exist controller information corresponding to the valid contact information stored in the OUT buffer 121b at the previous time, and contact information containing coordinates in the coordinate range of the exclusion area defined on the basis of the coordinates of (x11, y11).

Since no valid contact information is stored in the OUT buffer 121b in the state of (a) of FIG. 15, the coordinate output device 12 assumes the coordinates of (x11, y11) to be valid and outputs the same to the OUT buffer 121b (Step S19). Consequently, as illustrated in (a) of FIG. 16, valid contact information containing the coordinates (x11, y11) assumed to be valid, a new ID of ‘T1’, and touch start information is stored in the area 221 of the OUT buffer 121b. Further, the ID of “T1” and the controller information of “P11” are stored in correspondence with each other, in the ID correspondence table 122a.

In the area 222 of the OUT buffer 1221b, no valid contact information is stored. The coordinate output device 12, therefore, returns to Step S13, and subsequently, selects the contact information of “P31{(x31, y31),1}” stored in the buffer area 213 (Step S21: Yes, Step S22: No, S14). The coordinate output device 12 performs a touch determination operation with respect to the contact information of “P31 {(x31, y31),1}”, in the same manner as that for the above-described contact information of “P11{(x11, y11),1}”. Consequently, as illustrated in (b) of FIG. 16, valid contact information containing the coordinates of (x31, y31) assumed to be valid, a new ID of “T2”, and touch start information is stored in the area 222 of the OUT buffer 121b. The ID of “T2” and the controller information of “P31” are stored in correspondence with each other in the ID correspondence table 122a. Thereby, pieces of valid contact information the number of which is at the upper limit for output are stored in the OUT buffer 121b, and input information based on these pieces of valid contact information is output to the control device 3.

It is assumed that subsequently, in the state illustrated in FIG. 14, such an operation that the finger in contact with the contact position S11 leaves the first touch panel 101 and the finger in contact with the contact position S32 is slid to the vicinities of the contact position S31 is carried out. This causes, as illustrated in FIG. 17A, the contact position to shift from the contact position S32 to the contact position S33.

In this case, as illustrated in (b) of FIG. 15, in the buffer area 211A, contact information of “P11{(x11, y11),0}” containing release information is stored. In buffer area 213A, coordinates of (x31, y31) corresponding to the contact position S31 and hold information are stored. Further, in the buffer area 213B, contact information of “P31{(x33, y33),10}” containing hold information and corresponding to the contact position S33 is stored.

Though illustration is omitted for convenience sake, contact positions are detected during the shift from the contact position S32 to the contact position S33 at fixed time intervals. In the buffer area 213A, contact information corresponding to each detected contact position is stored at any time, and the above-described touch determination operation is performed.

In the buffer area 211A illustrated in (b) of FIG. 15, contact information of “P11{(x11, y11),0}” containing controller information of “P11” corresponding to the ID of “T1” of the valid contact information stored in the area 221 of the OUT buffer 121b illustrated in (b) of FIG. 16 is stored. Therefore, the coordinate output device 12 first selects this contact information of “P11{(x11, y11),0}” (Step S13: Yes, S20). Since release information is included in the contact information of “P11{(x11, y11),0}” (Step S15: Yes), the coordinate output device 12 determines whether or not the coordinates of (x11, y11) of this contact position S11 are within the boundary area of the first touch panel 101 (Step S16).

As illustrated in FIG. 17A, since the contact position S11 is outside the boundary area 100R (Step S16: No), the coordinate output device 12 determines the contact position S11 to be valid, and updates the area 221 of the OUT buffer 121b to a state illustrated in (c) of FIG. 16. In other words, in the area 221 of the OUT buffer 121b, valid contact information containing the coordinates of the contact position S11, the same ID of “T1” as that at the previous time, and the release information, is stored.

Further, in the buffer area 213A illustrated in (b) of FIG. 15, contact information of “P31{(x31, y31),10}” containing controller information of “P31” corresponding to the ID of “T2” of the valid contact information stored in the area 222 of the OUT buffer 121b illustrated in (b) of FIG. 16 is stored. The contact information of “P31{(x31, y31),10}” is contact information corresponding to the contact position S31. The coordinate output device 12 subsequently selects this contact information of “P31{(x31, y31),10}” (Step S13: Yes, S20). Since hold information is included in the contact information of “P31{(x31, y31),10}” (Step S15: No), the coordinate output device 12 makes a transition to an operation at Step S151.

The coordinate output device 12 sets a coordinate range of an exclusion area defined on the basis of the coordinates of (x31, y31) of the contact position S31, and determines whether or not coordinates of the contact information assumed to be valid exists in the coordinate range of the exclusion area. As illustrated in FIG. 17B, the contact position S33 is included in the exclusion area 10E defined on the basis of the contact position S31. In the contact information of the contact position S33 stored in the buffer area 213B illustrated in (b) of FIG. 15, the controller information of “P32” is stored. The controller information of “P32” is not stored in the ID correspondence table 122a, and the contact position S33 is not a valid contact position. Therefore, the contact position S31 is assumed to be valid, and valid contact information containing the coordinates of the contact position S31, the ID of “T2”, and hold information is stored in the area 222 of the OUT buffer 121b, as illustrated in (c) of FIG. 16. In (c) of FIG. 16, valid contact information containing release information is stored in the area 221, and after input information based on the valid contact information stored in the area 221 is output to the control device 3, this valid contact information is deleted.

In Embodiment 3 described above, in a case where a plurality of contact positions are detected on the touch panels 100, if a contact position that has been assumed to be valid exists in an exclusion area, the contact position is assumed to be valid, and the other contact positions are assumed to be invalid. In the same touch panel 100, in a case where one contact position exists in an exclusion area corresponding to another contact position, in other words, there are a plurality of contact positions close to one another, one of the contact positions may be assumed to be valid, whereby an input position on the touch panel 10 can be specified. Thus, with a configuration as that in Embodiment 3 described above, only the minimum required synthesized coordinates can be output to the control device 3.

### Embodiment 4

In the description of Embodiment 1 above, an example is described in which in a case where status information of selected contact information is not release information (in a case of “No” at Step S15 in FIG. 4), the contact information is assumed to be valid and is output to the OUT buffer 121b, but the configuration may be as follows.

FIG. 18 is an operation flow illustrating an exemplary operation of the input device 1 in the present embodiment. At Step S15 in FIG. 18, in a case where the status information of the selected contact information is not release information (Step S16: No), the coordinate output device 12 determines whether or not the contact position of the contact information is within the coordinate range of the boundary area (Step S111).

In a case where the contact position is within the coordinate range of the boundary area (Step S111: Yes), the coordinate output device 12 determines whether or not a contact position on another touch panel 100 exists in the coordinate range of the exclusion area defined on the basis of the contact position (Step S112). More specifically, the coordinate output device 12 sets a coordinate range of an exclusion area around synthesized coordinates as the center, the synthesized coordinates corresponding to the contact position, and determines whether or not synthesized coordinates on another touch panel are included in the coordinate range.

For example, as illustrated in FIG. 19A, in a case where a contact position S1 of selected contact information is within a boundary area 101r(100R) of the first touch panel 101 and a contact position S3 of the third touch panel 103 is in an exclusion area 10E of the contact position S1 (Step S112: Yes), the coordinate output device 12 assumes the contact position S3 to be invalid, and interpolates synthesized coordinates corresponding to the contact position S1 assumed to be valid (Step S113).

The following description describes an interpolation method. Let synthesized coordinates of the contact position S1 and the contact position S3 be (X1, Y1) and (X3, Y3), respectively, and let a Y-coordinate of a boundary L2 on the touch panel 10 be “Ym”.

(i) In a case where |Y1−Ym|≧|Y3−Ym|, that is, the distance to the contact position S1 assumed to be valid from the boundary L2 is greater than that for the contact position S3, interpolation coordinates of (X1′, Y1′) for (X1, Y1) are derived by an expression (1) below:

(X1′,Y1′)=(X1,Ym−(|Y3−Y1|/2)) Expression (1)

(ii) In a case where |Y1−Ym|≦|Y3−Ym|, that is, the distance to the contact position S1 assumed to be valid from the boundary L2 is smaller than that for the contact position S3, interpolation coordinates of (X1′, Y1′) are derived by an expression (2) below:

(X1′,Y1′)=(X1,Ym+(|Y3−Y1|/2)) Expression (2)

In a case where the contact position of the selected contact information in FIG. 19A is the contact position S3, the contact position S3 is assumed to be valid and the contact position S1 is assumed to be invalid, and synthesized coordinates corresponding to the contact position S3 are interpolated, the interpolation coordinates are derived in the following manner.

(i) In a case where |Y1−Ym|≧|Y3−Ym|, that is, the distance to the contact position S3 assumed to be valid from the boundary L2 is smaller than that for the contact position S1, interpolation coordinates of (X3′, Y3′) with respect to (X3, Y3) are derived by an expression (3) below:

(X3′,Y3′)=(X3,Ym−(|Y3−Y1|/2)) Expression (3)

(ii) In a case where |Y1−Ym|≦|Y3−Ym|, that is, the distance to the contact position S3 assumed to be valid from the boundary L2 is greater than that for the contact position S1, interpolation coordinates of (X3′, Y3′) are derived by an expression (4) below:

(X3′,Y3′)=(X3,Ym+(|Y3−Y1|/2)) Expression (4)

Further, for example, as illustrated in FIG. 19B, in a case where the contact position S3, which is an object to be determined, is in the boundary area 103r(100R) of the third touch panel 103, and the contact position S4 on the fourth touch panel 104 is in the exclusion area 10E for the contact position S3, the interpolation of synthesized coordinates for the contact position to be assumed to be valid is performed in the following manner. The synthesized coordinates of the contact position S3 and the contact position S4 are (X3, Y3) and (X4, Y4), respectively, and the X-coordinate of the boundary L1 in the touch panel 1 is given as “Xm”.

In a case where in this example, the contact position S3 is assumed to be valid and the contact position S4 is assumed to be invalid, and synthesized coordinates of the contact position S3 are interpolated by using the contact position S4, interpolation coordinates are derived by using an expression (5) or (6) below:

(i) In a case where |X3−Xm|≧|X4−Xm|, that is, the distance to the contact position S3 assumed to be valid from the boundary L1 is greater than that for the contact position S4:

(X3′,Y3′)=(Xm−|X3−X4|/2,Y3) Expression (5)

(ii) In a case where |X3−Xm|≦|X4−Xm|, that is, the distance to the contact position S3 assumed to be valid from the boundary L1 is smaller than that for the contact position S4:

(X3′,Y3′)=(Xm+|X3−X4|/2,Y3) Expression (6)

Further, in a case where, in this example, the contact position S4 is assumed to be valid and the contact position S3 is assumed to be invalid, and synthesized coordinates of the contact position S4 are interpolated by using the contact position S3, interpolation coordinates of (X4′, Y4′) are derived in the following manner.

(i) In a case where |X3−Xm|≧|X4−Xm|, that is, the distance to the contact position S4 assumed to be valid from the boundary L1 is smaller than that for the contact position S3:

(X4′,Y4′)=(Xm−|X3−X4|/2,Y3) Expression (7)

(ii) In a case where |X3−Xm|≦|X4−Xm|, that is, the distance to the contact position S4 assumed to be valid from the boundary L1 is greater than that for the contact position S3:

(X4′,Y4′)=(Xm+|X3−X4|/2,Y3) Expression (8)

In the present embodiment, in a case where a contact position of an object to be determined is in a boundary area and a contact position on another touch panel 100 is included in the exclusion area for the contact position, when the contact position is assumed to be valid and the contact position on another touch panel 100 is assumed to be invalid, synthesized coordinates the contact position assumed to be valid are interpolated by using synthesized coordinates of the contact position assumed to be invalid. In other words, at least one of components of the coordinates of the contact position assumed to be valid is shifted toward the touch panel 100 having the contact position located at a greater distance from the boundary, with respect to the boundary between the contact position assumed to be valid and the contact position assumed to be invalid as a reference, according to the distance between the contact positions. This configuration makes it possible to output more appropriate synthesized coordinates of the contact position assumed to be valid to the control device 3.

The embodiments of the present invention are described above, but the above-described embodiments are merely examples for implementing the present invention. The present invention, therefore, are not limited to the above-described embodiments, and the above-described embodiments can be appropriately varied and implemented without departing from the scope of the invention. Hereinafter, modification examples of the present invention are described.

### Modification

(1) In the description of Embodiments 1 to 4, an example is described in which, in a case where release information is included in selected contact information, when coordinates of the contact information are in a boundary area (Step S15: Yes, S16: Yes), an operation for determining whether or not any contact position on another touch panel 100 exists in an exclusion area (Step S17) is performed. The operation, however, may be performed irrespective of whether the contact position on another touch panel 100 is in the boundary area. In other words, the configuration may be as follows: in a case where release information is included, if a contact position on another touch panel 100 exists in an exclusion area defined on the basis of the coordinates of the contact information, the contact position on another touch panel 100 is assumed to be valid, and valid contact information containing the contact position is stored in the OUT buffer 121b.

(2) In the description of Embodiment 4 described above, an example is described in which, in a case where synthesized coordinates of contact positions on the touch panels 100 that are adjacent at the boundary L2 are interpolated, the Y-coordinates are interpolated. The X-coordinates, however, may be interpolated as well. More specifically, the X-coordinates in Expressions (1) to (4) described above are obtained in such a manner as Expressions (9) to (12) below, respectively:

(X1′,Y1′)=((X1+X3)/2,Ym−(|Y3−Y1|/2)) Expression (9)

(X1′,Y1′)=((X1+X3)/2,Ym+(|Y3−Y1|/2)) Expression (10)

(X3′,Y3′)=((X1+X3)/2,Ym−(|Y3−Y1|/2)) Expression (11)

(X3′,Y3′)=((X1+X3)/2,Ym+(|Y3−Y1|/2)) Expression (12)

This configuration makes it possible to interpolate components parallel to the boundary L2 in the coordinates of the contact position that is assumed to be valid as well. Thus, more appropriate synthesized coordinates according to contact can be output to the control device 3.

(3) In the description of Embodiments 1 to 4 described above, an example is described in which the exclusion area is in a circular shape having a predetermined radius, but the shape of the exclusion area is not limited to the circular shape, but may be a rectangular shape.

(4) In Embodiment 2 described above, in a case where there are a plurality of contact positions on another touch panel 100 that are located at the shortest distance to the center of the exclusion area 10E, a contact position on the another touch panel 100 that is positioned in a direction of a vector starting from the center of the exclusion area 10E, that is, the release position, may be selected.

(5) In the description of Embodiments 1 to 4 described above, an example is described in which, in a case where a contact position on another touch panel 100 is included in the exclusion area defined on the basis of the release position, the contact position on the another touch panel 100 is assumed to be valid, and a contact position that is the release position is not output to the control device 3. The configuration, however, may be as follows. Input information containing the contact position as the release position, the same ID as that of the contact position on another touch panel 100 assumed to be valid, and the hold information, may be output to the control device 3.

(6) In the description of Embodiments 1 to 4 described above, a touch panel 10 in which four touch panels 100 are arranged so as to be adjacent to one another is described as an example, but the configuration of the touch panel 10 is not limited to this. In other words, the touch panel 10 may at least have a configuration in which a plurality of touch panels 100 are arranged so as to be adjacent to one another.

(7) In the description of Embodiments 1 to 4 described above, an example is described in which, in the input device 1, a valid contact position is converted to synthesized coordinates on a coordinate plane of the touch panel 10. The position, however, may be converted to synthesized coordinates in the control device 3. For example, the input device 1 may output contact information of valid contact position as input information to the control device 3, and in the control device 3, the contact position may be converted into synthesized coordinates, by using conversion formulae, a conversion table, or the like for converting each contact position on the touch panel into synthesized coordinates.

1. An input device comprising:
a contact detection unit including a plurality of touch panels arranged so as to adjacent to one another, the contact detection unit detecting, as to each of the touch panels, an input operation on the touch panel, and outputting contact information that contains a contact position corresponding to the input operation on the touch panel, and release detection information that indicates whether or not the contact position is a release position at which the contact with the touch panel stopped;
a determination unit that determines an input position with respect to an entire surface of the plurality of touch panels, based on the contact position in the contact information output by the contact detection unit; and
an output unit that outputs the contact position determined to be the input position, as a contact position associated with the input operation corresponding to the said contact position, the input operation being detected by the contact detection unit,
wherein, in a case where the release detection information contained in the contact information for one of the touch panels indicates that the contact position is a release position, when a contact position on another touch panel exists in a predetermined area defined on the basis of the release position, the determination unit determines the contact position on the another touch panel to be the input position, and
the output unit outputs the contact position on the another touch panel, which is determined to be the input position, as a contact position associated with the input operation corresponding to the release position on the one of the touch panels, the input operation being detected by the contact detection unit.

2. The input device according to claim 1,
wherein, when the release position on the one of the touch panels is within a boundary area that includes a boundary with the another touch panel, in the one of the touch panels that includes the release position, the determination unit determines whether or not the contact position on the another touch panel exists within the predetermined area.

3. The input device according to claim 1,
wherein the determination unit determines a contact position on the another touch panel that is located at the shortest distance to the release position on the one of the touch panels and exists within the predetermined area, to be the input position.

4. The input device according to claim 1,
wherein the determination unit specifies a vector direction based on the release position on the one of the touch panels and another contact position on the one of the touch panels, and determines a contact position on the another touch panel positioned in the vector direction starting from the release position as a starting point, to be the input position.

5. The input device according to claim 2,
wherein, in a case where the release detection information contained in the contact information for the one of the touch panels indicates that the contact position is not a release position, when a contact position on another touch panel is included in a predetermined area that is within the boundary area in the touch panel including the contact position of the contact information and is defined on the basis of the contact position, the determination unit determines the contact position to be the input position, and
the input device further comprising:
a correction unit that corrects the contact position determined to be the input position, using the contact position on the another touch panel.

6. A non-transitory computer readable storage medium with a control program stored thereon, the control program causing a computer of an input device that includes a plurality of touch panels arranged so as to be adjacent to one another to execute:
a contact detection step of detecting, as to each of the touch panels, an input operation on the touch panel, and outputting contact information that contains a contact position corresponding to the input operation on the touch panel, and release detection information that indicates whether or not the contact position is a release position at which the contact with the touch panel stopped;
a determination step of determining an input position with respect to an entire surface of the plurality of touch panels, based on the contact position in the contact information output by the contact detection step; and
an output step of outputting the contact position determined to be the input position, as a contact position associated with the input operation corresponding to the said contact position, the input operation being detected in the contact detection step,
wherein, in a case where the release detection information contained in the contact information for one of the touch panels indicates that the contact position is a release position, when a contact position on another touch panel exists within a predetermined area defined on the basis of the release position, the determination step determines the contact position on the another touch panel to be the input position, and
the output step outputs the contact position on the another touch panel, which is determined to be the input position, as a contact position associated with the input operation corresponding to the release position on the one of the touch panels, the input operation being detected in the contact detection step.
